(19) United States
(12) Patent Application Publication
(10) Pub. No.: US 2019/0345591 A1
(43) Pub. Date: Nov. 14, 2019

(54) STAINLESS STEEL HAVING EXCELLENT CONTACT RESISTANCE FOR PEMFC SEPARATOR AND METHOD OF MANUFACTURING THE SAME

(71) Applicant: POSCO, Pohang-si Gyeongsangbuk-do (KR)

(72) Inventors: Jong Hee KIM, Yuseong-gu Daejeon (KR); Kwang-Min KIM, Pohang-si Gyeongsangbuk-do (KR); Bo Sung SEO, Pohang-si Gyeongsangbuk-do (KR)

(21) Appl. No.: 16/473,048

(22) PCT Filed: Nov. 30, 2017
(86) PCT No.: PCT/KR2017/013918

§ 371 Date: Jun. 24, 2019

(30) Foreign Application Priority Data
Dec. 22, 2016 (KR) 10-2016-0176695

(51) Int. Cl. C22C 38/28; H01M 8/021; C22C 38/26; C22C 38/24; C22C 38/22; C22C 38/04; C22C 38/02; C22C 38/00; C21D 9/46; C21D 8/02; C21D 6/00

(52) U.S. Cl. CPC C22C 38/28; H01M 2008/1095; C22C 38/26; C22C 38/24; C22C 38/22; C22C 38/04; C22C 38/02; C22C 38/008; C22C 38/002; C22C 38/001; C21D 9/46; C21D 8/0205; C21D 8/0226; C21D 8/0236; C21D 8/0263; C21D 6/002; H01M 8/021

(57) ABSTRACT

Stainless steel having excellent contact resistance for a PEMFC separator and a method for manufacturing the stainless steel are disclosed. The stainless steel for the Polymer Electrolyte Membrane Fuel Cell (PEMFC) separator according to an embodiment of the present disclosure may include: by weight percent, 0 to 0.02% of C (excluding 0%), 0 to 0.02% of N (excluding 0%), 0 to 0.25% of Si (excluding 0%), 0% to 0.2% of Mn (excluding 0%), 0 to 0.04% of P (excluding 0%), 0 to 0.02% of S (excluding 0%), 25 to 34% of Cr, 0 to 0.5% of Ti (excluding 0%), 0 to 0.5% of Nb (excluding 0%), 0 to 0.6% of Sn (excluding 0%) and the remainder comprising iron (Fe) and other unavoidable impurities, wherein the value of the following formula (1) with respect to the atomic ratio of X and Sn in the region within 3 nm in thickness from a surface of a passive film is 0.001 or more.

X/Sn formula (1)
Where X is Cl or F.

### TECHNICAL FIELD

The present disclosure relates to stainless steel for a PEMFC separator and a method of manufacturing the same, and more particularly, to stainless steel for a PEMFC separator having excellent contact resistance and a method for manufacturing the same.

### BACKGROUND ART

A Polymer Electrolyte Membrane Fuel Cell (PEMFC) is a fuel cell using a polymer film having hydrogen ion exchange properties as an electrolyte, and has a low operation temperature of about 80° C. and high efficiency compared to other types of fuel cells. Also, the PEMFC has fast startup, high output density, and a simple main-body structure. For these reasons, the PEMFC can be used for vehicles or homes.

The PEMFC has a unit cell structure in which gas diffusion layers and separators are stacked on both sides of a Membrane Electrode Assembly (MEA) consisting of an electrolyte, an anode electrode, and a cathode electrode. Several unit cells are connected in series to form a fuel cell stack.

The separators supply fuel (hydrogen and reformed gas) and an oxidizer (oxygen and air) to the electrodes of the fuel cell. In the separators, flow paths for discharging water, which is an electrochemical reactant, may be formed. The separators perform a function of mechanically supporting the MEA and the gas diffusion layers and a function of electrically connecting to neighboring unit cells.

Typically, the separators have been manufactured with a graphite material. However, recently, stainless steel is widely used to manufacture the separators, in consideration of the manufacturing cost, weight, etc. Stainless steel to be used to manufacture the separators should have excellent corrosiveness in a strong acidic environment which is the operating environment of fuel cells, and have excellent corrosion resistance in view of weight reduction, miniaturization, and productivity.

However, conventional stainless steel exhibits high resistance due to a passive film formed on a surface, which can lead to resistance loss in fuel cell performance, to overcome this problem, a process of coating a conductive material such as gold (Au), carbon, or nitride has been proposed.

However, these methods have problems in that the manufacturing cost and the manufacturing time are increased due to the additional process for coating a noble metal or a coating material, thereby reducing the productivity.

In order to solve these problems, studies are underway to lower the contact resistance by surface modification.

Patent Document 1 proposes stainless steel for the separator having low interfacial contact resistance and high corrosion potential by controlling the surface modification process. Patent Document 2 proposes a method of producing stainless steel having improved corrosion resistance and contact resistance by soaking stainless steel containing 17 to 23% Cr in a solution of [HF]≥[HNO₃]. Patent Document 3 proposes stainless steel having small contact resistance by controlling the atomic ratio of Cr and Fe to 1 or more in the passive film of stainless steel having 15 to 45% of Cr and 0.1 to 5% of Mo.

However, these methods have limitations in lowering the contact resistance of stainless steel in a fuel cell operating environment requiring long-term performance in a strong acid environment only by controlling the atomic ratio of Cr and Fe in the region within a few nm in thickness from the surface of the passive film.

(Patent Document 0001) Korean Patent Publication No. 10-2014-0081161

(Patent Document 0002) Korean Patent Publication No. 10-2013-0099148

(Patent Document 0003) Japanese Laid-Open Patent Publication No. 2004-149920

### DISCLOSURE

### Technical Problem

The present disclosure is directed to providing stainless steel for a Polymer Electrolyte Membrane Fuel Cell (PEMFC) separator capable of reducing contact resistance without an additional surface treatment by removing a non-conductive film formed on a surface of the stainless steel and improving the corrosion resistance by forming a new conductive film and by controlling the ratio of Cr and Sn, Cl, and F minor alloys in a passive film of a few nm in thickness of stainless steel.

The present disclosure also provides a method of manufacturing stainless steel for the PEMFC separator

### Technical Solution

Stainless steel for a Polymer Electrolyte Membrane Fuel Cell (PEMFC) separator according to an embodiment of the present disclosure may include: by weight percent, 0 to 0.02% of C (excluding 0%), 0 to 0.02% of N (excluding 0%), 0 to 0.25% of Si (excluding 0%), 0% to 0.2% of Mn (excluding 0%), 0 to 0.04% of P (excluding 0%), 0 to 0.02% of S (excluding 0%), 25 to 34% of Cr, 0 to 0.5% of Ti (excluding 0%), 0 to 0.5% of Nb (excluding 0%), 0 to 0.6% of Sn (excluding 0%) and the remainder comprising iron (Fe) and other unavoidable impurities, wherein the value of the following formula (1) with respect to the atomic ratio of X and Sn in the region within 3 nm in thickness from a surface of a passive film is 0.001 or more.

X/Sn formula (1)

Where X is Cl or F.

Further, according to an embodiment of the present disclosure, the contact resistance index defined by the following formula (2) relating to the content of Cr and Sn may be 25 or more,

The value of the following formula (3) with respect to the atomic ratio of Sn and Cr in a region within 3 nm in thickness from the surface of the passive film may be 0.001 or more.

Cr+10Sn formula (2)

(10*Sn)/Cr formula (3)

Further, according to an embodiment of the present disclosure, the value of the formula (3) may be 0.004 or more.

Also, according to an embodiment of the present disclosure, the contact resistance of the stainless steel may be 20 mΩ·cm² or less.

Also, according to an embodiment of the present disclosure, it may further include at least one selected from a group consisting of 0 to 0.6% of Cu (excluding 0%), 0 to 0.6% of V (excluding 0%), and 0.05 to 2.5% of Mo.

According to an embodiment of the present disclosure, there is provided a method of manufacturing stainless steel for a Polymer Electrolyte Membrane Fuel Cell (PEMFC) separator, the method including: hot-rolling and cold-rolling stainless steel comprising by weight percent, 0 to 0.02% of C (excluding 0%), 0 to 0.02% of N (excluding 0%), 0 to 0.25% of Si (excluding 0%), 0% to 0.2% of Mn (excluding 0%), 0 to 0.04% of P (excluding 0%), 0 to 0.02% of S (excluding 0%), 25 to 34% of Cr, 0 to 0.5% of Ti (excluding 0%), 0 to 0.5% of Nb (excluding 0%), 0 to 0.6% of Sn (excluding 0%), and the remainder comprising iron (Fe) and other unavoidable impurities, to manufacture a cold-rolled thin steel sheet; and soaking the cold-rolled thin steel sheet in an acid solution containing at least one of Cl or F.

Also, according to an embodiment of the present invention, the acid solution may include hydrochloric acid or hydrofluoric acid.

### Advantageous Effects

According to an embodiment of the present disclosure, a non-conductive film formed on the surface of the stainless steel is removed and a new conductive film is formed to improve the corrosion resistance. At the same time, the contact resistance can be reduced without having to perform separate surface processing such as coating by controlling the ratio of Cr and Sn, Cl, and F minor alloys in the passive film of the stainless steel.

### DESCRIPTION OF DRAWINGS

FIG. 1 is a cross-sectional view of a unit cell for describing a typical polymer fuel cell.

FIG. 2 is for describing the correlation between the content of components in stainless steel, the atomic ratio in a passive film, and the contact resistance according to an embodiment of the present disclosure.

[Modes of the Invention]

Hereinafter, the embodiments of the present disclosure will be described in detail with reference to the accompanying drawings. The following embodiments are provided to transfer the technical concepts of the present disclosure to one of ordinary skill in the art. However, the present disclosure is not limited to these embodiments, and may be embodied in another form. In the drawings, parts that are irrelevant to the descriptions may be not shown in order to clarify the present disclosure, and also, for easy understanding, the sizes of components are more or less exaggeratedly shown.

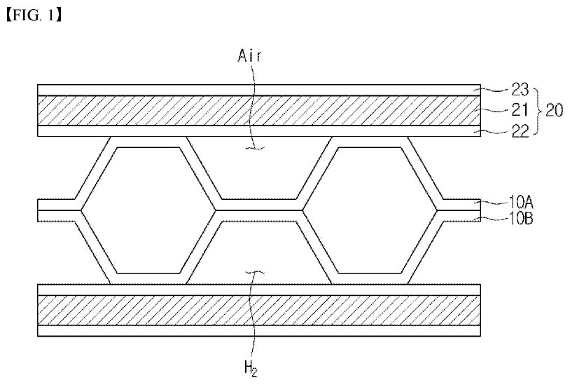

FIG. 1 is a cross-sectional view of a unit cell for describing a typical polymer fuel cell. Referring to FIG. 1, a Polymer Electrolyte Membrane Fuel Cell (PEMFC) may have a unit cell structure in which a gas diffusion layer (22, 23) and a separator are stacked on both sides of a membrane electrode assembly (21) consisting of an electrolyte, an anode and a cathode electrode.

The separators supply fuel (hydrogen) and an oxidizer (air) to the electrodes of the fuel cell. In the separators, flow paths for discharging water, which is an electrochemical reactant, may be formed. The separators perform a function of mechanically supporting the membrane electrode assembly (21) and the gas diffusion layers (22,23) and a function of electrically connecting to neighboring unit cells.

A flow path of the PEMFC separator is composed of a channel through which fuel or an oxidizer passes, and a land, which is in contact with gas diffusion layers, to function as an electrical passage. In order to easily supply reactants and easily discharge products, it is very important to control the shape and surface state of the flow path.

A material to be applied to a separator (10) should have excellent corrosiveness in a strong acidic environment, which is the operating environment of fuel cells, and should be made of stainless steel excellent in corrosion resistance and conductivity in view of weight reduction, miniaturization, and productivity.

Accordingly, the separator (10) includes the stainless steel according to an embodiment of the present disclosure.

The stainless steel includes: by weight percent, 0 to 0.02% of C (excluding 0%), 0 to 0.02% of N (excluding 0%), 0 to 0.25% of Si (excluding 0%), 0 to 0.2% of Mn (excluding 0%), 0 to 0.04% of P (excluding 0%), 0 to 0.02% of S (excluding 0%), 25 to 34% of Cr, 0 to 0.5% of Ti (excluding 0%), 0 to 0.5% of Nb (excluding 0%), 0 to 0.6% of Sn (excluding 0%), and the remainder comprising iron (Fe) and other unavoidable impurities.

Hereinafter, a reason for the numerical limitation of element contents according to the embodiments of the present disclosure will be described. In the following description, a unit of weight percentage (wt %) will be used unless otherwise noted.

C: 0 to 0.02% (excluding 0%), N: 0 to 0.02% (excluding 0%)

Carbon (C) and nitrogen (N) may form Cr carbonitride of the stainless steel. As a result, the corrosion resistance of a layer with a lack of chrome (Cr) may be degraded. Accordingly, as the carbon (C) content and the nitrogen (N) content are lower, it will be more preferable. Therefore, in the present disclosure, the carbon (C) content may be limited to 0.02 wt % or less (excluding 0%), and the nitrogen (N) content may be preferably limited to 0.02 wt % or less (excluding 0%).

Si: 0 to 0.25% (excluding 0%)

Although silicon (Si) is an element that is effective for deacidification, silicon (Si) suppresses toughness and formability, and SiO2 oxide produced during annealing degrades conductivity of a product. Therefore, in the present disclosure, the silicon (Si) content may be preferably limited to 0.25 wt % or less.

Mn: 0 to 0.2% (excluding 0%)

Although manganese (Mn) is an element that is effective for deacidification, MnS, which is an inclusion, may reduce the corrosion resistance. Therefore, in the present disclosure, the manganese (Mn) content may be preferably limited to 0.2 wt % or less.

P: 0 to 0.04% (excluding 0%)

Since phosphorus (P) reduces toughness as well as corrosion resistance, in the present disclosure, the phosphorus (P) content may be preferably limited to 0.04 wt % or less.

S: 0 to 0.02% (excluding 0%)

Sulfur (S) may form MnS, and MnS may become a start point of corrosion to thereby reduce the corrosion resistance. Therefore, in the present disclosure, the sulfur (S) content may be preferably limited to 0.02 wt % or less.

Cr: 25 to 34%

Chrome (Cr) is an element increasing corrosion resistance in an acidic atmosphere in which the fuel cell operates. However, if chrome (Cr) is excessively added, chrome (Cr) may reduce toughness. Therefore, in the present disclosure, the chrome (Cr) content may be preferably limited to 25 to 34 wt %.

Ti: 0 to 0.04% (excluding 0%), Nb: P: 0 to 0.5% (excluding 0%)

Although titanium (Ti) and niobium (Nb) are elements that are effective in forming carbonitride from carbon (C) and nitrogen (N) in the steel, titanium (Ti) and niobium (Nb) may degrade toughness. Therefore, in the present disclosure, the titanium (Ti) content and the niobium (Nb) content may be preferably limited to 0.5 wt % or less.

Sn: 0 to 0.6% (excluding 0%)

Sn is an element which lowers the contact resistance due to the dissolving of the a surface passive film, but it is preferable to limit the upper limit to 0.6%, because it inhibits hot workability when added in excess.

In the present disclosure, Cr and Sn are elements contributing to lowering contact resistance, it has been found that when the Cr+10*Sn expressed by the contact resistance index is 25% or more by weight percent, it contributes to lowering the contact resistance, which will be described in detail later.

Stainless steel according to an embodiment of the present disclosure may further include at least one selected from a group consisting of 0 to 0.6% of Cu (excluding 0%), 0 to 0.6% of V (excluding 0%), and 0.05 to 2.5% of Mo.

Cu: 0 to 0.6% (excluding 0%), Ni: 0 to 0.6% (excluding 0%)

Copper (Cu) is an element whose formability may deteriorate due to solid solution hardening, and nickel (Ni) is an element whose elution and formability may deteriorate when it is added by a small amount. Accordingly, copper (Cu) and nickel (Ni) are considered as impurities in the present disclosure.

V: 0 to 0.6% (excluding 0%)

Vanadium (V) may be effective in lowering the elution of iron (Fe) in an environment in which the fuel cell operates. However, if vanadium (V) is excessively added, vanadium (V) may degrade toughness. Therefore, in the present disclosure, the vanadium (V) content may be preferably limited to 0 to 0.6 wt %.

Mo: 0.05 to 2.5%

Molybdenum (Mo) may be added as an element for increasing the corrosion resistance of the stainless steel. However, if molybdenum (Mo) is excessively added, toughness and hydrophilicity may be more or less degraded. Therefore, in the present disclosure, molybdenum (Mo) may be preferably limited to 0.05 to 2.5 wt %.

Stainless steel for the PEMFC separator according to an embodiment of the present disclosure has a contact resistance index of 25 or more, which is defined by the following formula (1) with respect to the content of Cr and Sn.

Cr+10Sn formula (1)

Cr and Sn act as advantageous elements for inhibiting the growth of the passive film at the fuel cell operating potential. Therefore, when the contact resistance index according to formula (1) is less than 25, there is a problem that the contact resistance durability is poor.

For example, the stainless steel having the value of the following formula (2) with respect to the atomic ratio of Sn and Cr in the region within 3 nm in thickness from the surface of the passive film is 0.001 or more.

(10*Sn)/Cr formula (2)

Cr and Sn act as facilitating the passage of electrons through the passive film of the thin film due to the formation of Sn oxide in the Cr oxide in the passive film and suppress the formation of insulating pores and insulating oxides of the passive film, and make the passive film thinner. Therefore, when the value of formula (2) is less than 0.001, the contact resistance cannot be sufficiently lowered.

Accordingly, the stainless steel may have an interfacial contact resistance of 20 mΩ·cm² or less at a contact pressure of 140 N/cm².

For example, it may be more preferable that the value of formula (2) is 0.004 or more. Accordingly, the contact resistance of the stainless steel may be 15 mΩ·cm² or less.

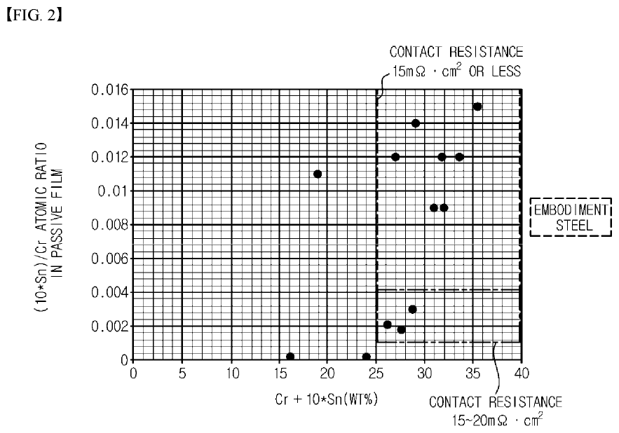

FIG. 2 is for describing the correlation between the content of components in stainless steel, the atomic ratio in a passive film, and the contact resistance according to an embodiment of the present disclosure.

Referring to FIG. 2, Cr+10Sn and (10*Sn)/Cr values of stainless steel according to embodiments of the present disclosure are shown and the results of measurement of their contact resistance are shown. Thus, it can be seen that the stainless steel satisfying the above-mentioned formulas (1) and (2) exhibits excellent characteristics with a contact resistance of 20 mΩ·cm² or less and has a performance exceeding 20 mΩ·cm² in other regions.

Also, for example, the value of the following formula (3) with respect to the atomic ratio of X and Sn in the region within 3 nm in thickness from the surface of the passive film is 0.001 or more.

X/Sn formula (3)

Where X is Cl or F.

The passive film of the stainless steel includes Sn oxide, thus, Cl or F ions may be doped with Sn oxide through a soaking step in an acid solution containing at least one of Cl or F. For this reason, the contact resistance of the stainless steel can be further reduced.

Accordingly, the contact resistance of the stainless steel may be 20 mΩ·cm² or less. Preferably, the contact resistance of the stainless steel can be controlled to be 10 mΩ·cm² or less, and accordingly, a target value for commercialization of the PEMFC separator can be achieved.

For example, the thickness of the passive film may be 3.5 nm or less (excluding 0%). In the case of a typical stainless cold-rolled thin steel sheet, the interfacial contact resistance increases by a passive film of a few nanometers (nm) in thickness formed on a surface. Since the passive film of the stainless steel according to an embodiment of the present disclosure is thinned to 3.5 nm or thinner, an effect of reducing the contact resistance by thinning of the passive film having semiconductive characteristics close to insulation may be obtained.

For example, a corrosion potential of the passive film may be 0.3 V (SCE) or higher. The corrosion potential was obtained by cutting a steel sheet material of 0.1 mm in thickness to an area of cm², soaking the steel sheet material at 70° C. in a mixture solution of 1 mole of sulfuric acid and 2 ppm of hydrofluoric acid, which is an operating environment of fuel cells, and then evaluating the potential of the resultant material compared to a saturated calomel electrode (SCE), which is a reference electrode. That is, the stainless steel 10 according to an embodiment of the present disclosure can secure a corrosion potential of 0.3 V (SEC) or higher compared to the saturated calomel electrode (SCE), which is a reference electrode

That is, the stainless steel for the PEMFC separator according to an embodiment of the present disclosure may include the passive film having hydrophilicity, conductivity, corrosion resistance, and low contact resistance.

The stainless steel for the PEMFC separator may be manufactured as a cold-rolled thin steel sheet through hot-rolling and cold-rolling.

The cold-rolled thin steel sheet may include by weight percent, 0 to 0.02% of C (excluding 0%), 0 to 0.02% of N (excluding 0%), 0 to 0.25% of Si (excluding 0%), 0 to 0.2% of Mn (excluding 0%), 0 to 0.04% of P (excluding 0%), 0 to 0.02% of S (excluding 0%), 25 to 34% of Cr, 0 to 0.5% of Ti (excluding 0%), 0 to 0.5% of Nb (excluding 0%), 0 to 0.6% of Sn and the remainder comprising iron (Fe) and other unavoidable impurities. The individual elements have been described above.

The cold-rolled thin steel sheet has a Cr+10Sn value of 25 or more and (10*Sn)/Cr value of 0.001 or more in formula (2), and accordingly, the stainless steel having an interfacial contact resistance of 20 mΩ·cm² or less at a contact pressure of 140 N/cm² has excellent contact resistance.

The passive film of the stainless steel includes Sn oxide, thus, the Cl or F ions may be doped into Sn oxide through additionally performing a soaking step in an acid solution containing at least one of Cl or F during the manufacturing processing of stainless steel. For this reason, the contact resistance of the stainless steel can be further reduced.

That is, the contact resistance of the stainless steel cold-rolled thin steel sheet through the step of soaking in the acid solution can be controlled to 10 mΩ·cm² or less, and accordingly, it is possible to achieve a target value for commercialization of the PEMFC separator.

For example, the acid solution may include hydrochloric acid or hydrofluoric acid.

The acid solution may be used solely with hydrochloric acid or hydrofluoric acid, or may include a mixed acid solution including hydrochloric or hydrofluoric acid with another acid solution. For example, the acid solution may include 5 to 20% by weight of hydrochloric acid, or a mixed solution of 5 to 20% by weight of nitric acid and 1 to 5% by weight of hydrofluoric acid may be used.

For example, the cold-rolled thin steel sheet may be soaked in the acid solution at 70° C. or lower for 30 to 600 seconds.

Hereinafter, the present disclosure will be described in more detail through embodiments below.

### Embodiment

Embodiment steel 1 to 10 according to the present disclosure and comparative steel 1 to 3 include composites shown in Table 1, and may be manufactured through 50 kg ingot casting. An ingot was heated at 1,200° C. for 3 hours and hot-rolled to a thickness of 4 mm. The hot-rolled steel sheet was subjected to cold-rolling at a final cold rolling thickness of 0.2 mm and then annealed at 960° C. Thereafter, the final cold-rolled annealed sheet was polished up to a sand paper #1200, soaked in a 5 wt % nitric acid aqueous solution at 50° C., and contact resistance and surface analysis were performed with the manufactured test pieces.

TABLE 1

| | C | N | Si | Mn | P | S | Cr | Sn | Mo | V | Ti | Nb |
|---|---|---|---|---|---|---|---|---|---|---|---|---|
| Embodiment | 0.009 | 0.01 | 0.15 | 0.14 | 0.009 | 0.008 | 30 | 0.1 | — | 0.1 | 0.1 | 0.2 |
| steel 1 | | | | | | | | | | | | |
| Embodiment | 0.01 | 0.011 | 0.14 | 0.12 | 0.01 | 0.009 | 27.1 | 0.053 | — | 0.2 | 0.15 | 0.15 |
| steel 2 | | | | | | | | | | | | |
| Embodiment | 0.008 | 0.009 | 0.11 | 0.15 | 0.03 | 0.004 | 28.3 | 0.05 | — | 0.42 | 0.11 | 0.25 |
| steel 3 | | | | | | | | | | | | |
| Embodiment | 0.01 | 0.015 | 0.12 | 0.16 | 0.018 | 0.007 | 33 | 0.06 | 1 | — | 0.05 | 0.12 |
| steel 4 | | | | | | | | | | | | |
| Embodiment | 0.09 | 0.018 | 0.14 | 0.18 | 0.017 | 0.006 | 26 | 0.1 | — | 0.39 | 0.1 | 0.1 |
| steel 5 | | | | | | | | | | | | |
| Embodiment | 0.003 | 0.011 | 0.15 | 0.14 | 0.015 | 0.008 | 27.1 | 0.2 | — | — | 0.18 | 0.2 |
| steel 6 | | | | | | | | | | | | |
| Embodiment | 0.009 | 0.012 | 0.19 | 0.19 | 0.018 | 0.008 | 29.3 | 0.25 | — | — | 0.2 | 0.12 |
| steel 7 | | | | | | | | | | | | |
| Embodiment | 0.009 | 0.01 | 0.17 | 0.18 | 0.019 | 0.009 | 31 | 0.45 | — | — | 0.02 | 0.1 |
| steel 8 | | | | | | | | | | | | |
| Embodiment | 0.01 | 0.009 | 0.16 | 0.17 | 0.01 | 0.006 | 25.7 | 0.05 | — | — | 0.05 | 0.2 |
| steel 9 | | | | | | | | | | | | |
| Embodiment | 0.012 | 0.008 | 0.15 | 0.11 | 0.02 | 0.005 | 31 | 0.1 | — | — | 0.051 | 0.05 |
| steel 10 | | | | | | | | | | | | |
| Comparative | 0.01 | 0.009 | 0.13 | 0.18 | 0.017 | 0.007 | 22 | 0.2 | — | — | 0.1 | 0.05 |
| steel 1 | | | | | | | | | | | | |
| Comparative | 0.013 | 0.008 | 0.16 | 0.14 | 0.015 | 0.003 | 17 | 0.2 | — | — | — | 0.17 |
| steel 2 | | | | | | | | | | | | |
| Comparative | 0.011 | 0.007 | 0.17 | 0.19 | 0.018 | 0.009 | 15 | 0.12 | — | — | 0.05 | 0.1 |
| steel 3 | | | | | | | | | | | | |

The surface analysis was analyzed by X-ray photoelectron spectroscopy (XPS). The atomic ratio of Cr and Sn in the Cr oxide and Sn oxide peaks analyzed in the 2.9 nm region on a surface were calculated.

The contact resistance was evaluated by preparing two manufactured sheets of 0.2 mm in thickness, placing carbon paper (SGL-10BA) between the two sheets, and calculating the average value after valuating interfacial contact resistance four times at a contact pressure of 140N/cm². The contact resistance was evaluated by the initial contact resistance of the test pieces after soaking them in a 5 wt % nitric acid aqueous solution at 50° C. by polishing up to a sand paper #1200. The contact resistance was evaluated after applying a 0.7V vs. SCE constant current for 100 hours in a solution of 1M H2504+2 ppm HF at 80° C.

The judgment of fitness of contact resistance durability was evaluated by evaluating the initial contact resistance and the contact resistance after applying a 0.7V vs. SCE constant current for 100 hours in a solution of 1M H₂SO₄+2 ppm HF at 80° C. and when all satisfy 20 mΩ·cm² or less, it was considered as good (O) or otherwise, it was judged as unsuitable (X)

TABLE 2

| | | | | Contact resistance after | |
|---|---|---|---|---|---|
| | | | | applying 0.7 V vs. SCE | |
| | | | | constant current for 100 | |
| | | | Initial contact | hours in a solution of 1M | Contact |
| | Cr + 10Sn | 10*Sn/Cr | resistance | H₂SO₄ + 2 ppm HF at 80° C. | resistance |
| | (wt %) | (at %) | (mΩ · cm²) | (mΩ · cm²) | durability |
| Embodiment steel 1 | 31 | 0.009 | 10 | 11 | ◯ |
| Embodiment steel 2 | 27.63 | 0.0018 | 17 | 19 | ◯ |
| Embodiment steel 3 | 28.8 | 0.003 | 16 | 15 | ◯ |
| Embodiment steel 4 | 33.6 | 0.012 | 13 | 12 | ◯ |
| Embodiment steel 5 | 27 | 0.012 | 11 | 14 | ◯ |
| Embodiment steel 6 | 29.1 | 0.014 | 12 | 12.5 | ◯ |
| Embodiment steel 7 | 31.8 | 0.012 | 9 | 12 | ◯ |
| Embodiment steel 8 | 35.5 | 0.015 | 8 | 9 | ◯ |
| Embodiment steel 9 | 26.2 | 0.0021 | 17 | 19 | ◯ |
| Embodiment steel 10 | 32 | 0.009 | 12 | 14 | ◯ |
| Comparative steel 1 | 24 | 0.0002 | 79 | 167 | X |
| Comparative steel 2 | 19 | 0.011 | 18 | 250 | X |
| Comparative steel 3 | 16.2 | 0.0002 | 89 | 670 | X |

FIG. 2 is for describing the correlation between the content of components in the stainless steel, the atomic ratio in the passive film, and the contact resistance according to an embodiment of the present disclosure.

Referring to Table 2 and FIG. 2, it was found that the stainless steel having a Cr+10Sn value of 25 or more according to formula (1) and a (10*Sn)/Cr value of 0.001 or more according to formula (2) exhibits excellent characteristics with a contact resistance of 20 mΩ·cm² or less and it can be seen that the other region has a low performance of more than 20 mΩ·cm².

Thereafter, the final cold-rolled annealed sheet according to the steel 1 was soaked in an additional acid solution as shown in Table 4, and the properties thereof were evaluated again.

TABLE 3

| | | | | | | Contact resistance | |
|---|---|---|---|---|---|---|---|
| | | | | | | after applying 0.7 V | |
| | | | | | | vs. SCE constant | |
| | | | | | Initial | current for 100 horns | |
| | | | | | contact | in a solution of 1M | Contact |
| | | Acid | Temperature | X/Sn ratio | resistance | H₂SO₄ + 2 ppm HF | resistance |
| | Steel | solution | and Hours | (at %) | (mΩ · cm²) | at 80° C. (mΩ · cm²) | durability |
| Embodiment 1 | Embodiment | 10 wt % HCl | 50° C./1 min. | 0.0012 | 6 | 6.1 | ◯ |
| | steel 1 | | | | | | |
| Embodiment 2 | Embodiment | 10 wt % HNO₃ + | 50° C./1 min. | 0.0016 | 6.2 | 6.1 | ◯ |
| | steel 2 | 3 wt % HF | | | | | |

Referring to Table 3, it was found that contact resistance was further improved by soaking the final cold-rolled annealed sheet of the Steel 1 in an acid solution. This means that Cl or F ions can be doped into the Sn oxide present in the surface passive film, as a result, it was confirmed that the value of X/Sn with respect to the atomic ratio of X and Sn in the region within 3 nm in thickness from the surface of the passive film satisfies 0.001 or more, and the contact resistance is improved. In the present disclosure, hydrochloric acid and nitric acid+hydrofluoric acid are used as the soaking solution, but it is possible to use other acid solutions containing Cl or F ions.

That is, the stainless steel according to an embodiment of the present disclosure may secure the contact resistance without having to perform separate surface processing such as coating on the surface of the stainless steel for the PEMFC separator.

While the present disclosure has been particularly described with reference to exemplary embodiments, it should be understood by those skilled in the art that various changes in form and details may be made without departing from the spirit and scope of the present disclosure.

| | |
|---|---|
| 10: PEMFC separator | |
| 10A: cathode separator, 10B: anode separator | |
| 11: stainless steel | 12: passive film |
| 21: membrane electrode assembly | 22, 23: gas diffusion |
| | layer |

1. Stainless steel with improved contact resistance for a Polymer Electrolyte Membrane Fuel Cell (PEMFC) separator, the stainless steel comprising: by weight percent, 0 to 0.02% of C (excluding 0%), 0 to 0.02% of N (excluding 0%), 0 to 0.25% of Si (excluding 0%), 0% to 0.2% of Mn (excluding 0%), 0 to 0.04% of P (excluding 0%), 0 to 0.02% of S (excluding 0%), 25 to 34% of Cr, 0 to 0.5% of Ti (excluding 0%), 0 to 0.5% of Nb (excluding 0%), 0 to 0.6% of Sn (excluding 0%) and the remainder comprising iron (Fe) and other unavoidable impurities, wherein the value of the following formula (1) with respect to the atomic ratio of X and Sn in the region within 3 nm in thickness of a surface of a passive film is 0.001 or more.
X/Sn formula (1)
Where X is Cl or F.

2. The stainless steel of claim 1, wherein the contact resistance index defined by the following formula (2) relating to the content of Cr and Sn is 25 or more and the value of the following formula (3) with respect to the atomic ratio of Sn and Cr in a region within 3 nm in thickness from the surface of the passive film is 0.001 or more.
Cr+10Sn formula (2))
(10*Sn)/Cr formula (3)

3. The stainless steel of claim 2, wherein the value of formula (3) is 0.004 or more.

4. The stainless steel of claim 1, wherein the contact resistance of the stainless steel may be 20 mΩ·cm2 or less.

5. The stainless steel of claim 1, wherein the stainless steel further includes at least one selected from a group consisting of 0 to 0.6% of Cu (excluding 0%), 0 to 0.6% of V (excluding 0%), and 0.05 to 2.5% of Mo.

6. A method of manufacturing stainless steel with improved contact resistance for a Polymer Electrolyte Membrane Fuel Cell (PEMFC) separator, the method comprising: hot-rolling and cold-rolling stainless steel comprising by weight percent, 0 to 0.02% of C (excluding 0%), 0 to 0.02% of N (excluding 0%), 0 to 0.25% of Si (excluding 0%), 0% to 0.2% of Mn (excluding 0%), 0 to 0.04% of P (excluding 0%), 0 to 0.02% of S (excluding 0%), 25 to 34% of Cr, 0 to 0.5% of Ti (excluding 0%), 0 to 0.5% of Nb (excluding 0%), 0 to 0.6% of Sn (excluding 0%), and the remainder comprising iron (Fe) and other unavoidable impurities, to manufacture a cold-rolled thin steel sheet; and soaking the cold-rolled thin steel sheet in an acid solution containing at least one of Cl or F.

7. The method of claim 6, wherein the acid solution includes hydrochloric acid or hydrofluoric acid.
